(19) United States
(12) Patent Application Publication
(10) Pub. No.: US 2011/0210710 A1
(43) Pub. Date: Sep. 1, 2011

(54) STEP-UP DC-DC CONVERTER AND SEMICONDUCTOR INTEGRATED CIRCUIT DEVICE

(75) Inventors: Masahiko YAMAMOTO, Fussa (JP); Takao Okazaki, Hamura (JP)

(73) Assignee: HITACHI, LTD.

(21) Appl. No.: 12/987,114

(22) Filed: Jan. 8, 2011

(30) Foreign Application Priority Data
Feb. 26, 2010 (JP) 2010-041279

(51) Int. Cl. G05F 1/565

(52) U.S. Cl. 323/282

(57) ABSTRACT

A semiconductor integrated circuit device includes: a semiconductor switching element; an input voltage detection circuit that outputs a voltage correlated to an input voltage; an oscillator circuit that oscillates on the basis of the voltage outputted by the input voltage detection circuit; a control logic that generates a drive signal; a power supply circuit that boosts a battery voltage; a buffer that level-shifts the drive voltage outputted by the control logic; and an amplification element that operates using a voltage generated by the semiconductor switching element as a power supply. Thus, the semiconductor switching element can be on/off controlled so that switching loss at low load can be reduced while preventing the peak current flowing into the inductor coil from depending on the input voltage.

### CLAIM OF PRIORITY

The present application claims priority from Japanese patent application JP 2010-041279 filed on Feb. 26, 2010, the content of which is hereby incorporated by reference into this application.

### FIELD OF THE INVENTION

The present invention relates to a step-up DC-DC converter and, in particular, a step-up DC-DC converter for stably operating a high-voltage amplifier or the like that is driven by a battery power supply and outputs a voltage having an amplitude several tens of times greater than that of the voltage (for example, several volts) of the battery power supply, and a semiconductor integrated circuit device where the step-up DC-DC converter is integrally formed on a semiconductor substrate.

### BACKGROUND OF THE INVENTION

There has been a technology that includes an output feedback loop and an additional input forward control loop as a converter circuit for converting an input signal having a first value into an output signal having a second value on the basis of switching operation mode and as a method for performing such conversion and that is intended to cause the additional input forward control loop to control the switching parameters properly not only with respect to the output load but also over a wide input voltage range (for example, JP-A-Hei07-123706).

There has also been a technology that is intended to improve the power factor of a power supply circuit for converting an alternating-current power supply into a direct-current output voltage by controlling the switching frequency of a switching element depending on the alternating-current power supply voltage value (for example, see JP-A-2004-282958).

### SUMMARY OF THE INVENTION

As battery-driven apparatuses such as electronic apparatuses increase in recent years, the apparatuses have been required to operate at a low voltage, as well as to output a high voltage. To meet these requirements, there have been used boost DC-DC converters, which converts an input DC voltage into an output DC voltage by boosting the input DC voltage.

FIG. 2 is a diagram showing an example circuit configuration of a step-up DC-DC converter contemplated by the inventors prior to the present invention.

The step-up DC-DC converter includes at least one switch, an inductor coil connected to the at least one switch, and a controller that can provide a control signal. The above-mentioned at least one switch responds to a control signal in a first state where the at least one switch is turned on during an on time interval that is set on the basis of an input DC voltage and a constant.

This circuit generates an output voltage VDC from an input voltage VBAT using a step-up DC-DC converter, and the output voltage VDC is provided to a load. The load is, for example, an amplification element or the like.

The step-up DC-DC converter includes a boost circuit including a switching element, and a switching element control unit for on/off controlling the switching element. The boost circuit include, for example, an inductor coil L, a diode D, and a controllable semiconductor switching element 20, which include a transistor or a different element.

On the other hand, the technology disclosed in the above-mentioned JP-A-Hei07-123706 includes an output feedback loop and an additional input forward control loop as a converter circuit for converting an input signal having a first value into an output signal having a second value on the basis of switching operation mode and as a method for performing such conversion. The technology is intended to cause the additional input forward control loop to control the switching parameters properly not only with respect to an output load but also over a wide input voltage range.

A frequency change circuit 14 divides a clock signal (b) from an oscillator circuit 13, as well as changes the division output on the basis of an output from a power supply voltage detection circuit 10, which detects an input voltage VBAT, so as to adjust the frequency. A maximum duty setting circuit 15 receives an output (c) from the frequency change circuit 14 so as to set the maximum duties of an on period and an off period of a switching transistor 5. A drive circuit 16 directly drives the switching transistor 5 using outputs (d, f) from the maximum duty setting circuit 15 and a comparator circuit 9.

An output voltage Vout is detected by an output detection circuit 8, and a voltage correlated to the output voltage is outputted. The comparator circuit 9 compares this value with a voltage value obtained by converting a current value corresponding to the coil current using a current detection resistor 6.

If the voltage VBAT of a battery 1 is relatively high, a relatively high frequency is selected by the frequency change circuit 14, and a time ton during which the switching transistor is on is shortened. Thus, an inrush current is set such that it does not exceed any of the magnetic saturation current of a coil 2 and the maximum rating of the switching transistor 5.

However, in this configuration, the switching frequency of the switching element at low load is controlled by the period of the switching frequency. Thus, the switching frequency cannot be reduced. This disadvantageously increases switching loss.

Moreover, since feedback control always requires use of the current detection resistor 6, the resistor undesirably increases loss, reducing efficiency.

The technology disclosed in the above-mentioned JP-A-2004-282958 is intended to improve the power factor by rectifying an alternating-current power supply voltage of an alternating-current power supply using a rectifier circuit and converting the rectified voltage into a direct-current output voltage by turning on or off a switching element Q1 via a boost inductor coil. The power-factor improvement circuit changes the switching frequency of a switch depending on the alternating-current power supply voltage value and reduces the switching frequency or stops operation of the switch in a low part of the alternating-current power supply voltage so as to reduce power loss in the low part.

The switching element Q1 is configured to be turned on or off under the PWM control of a control circuit 100. The current detection resistor R detects the input current flowing into a full-wave rectifier circuit B1. A PWM comparator 116 outputs a duty cycle corresponding to the difference signal between the voltage of the current detection resistor R and an output of a multiplier 112 generated by an error amplifier 113 so as to drive the switching element Q1.

However, in this configuration, as in the configuration described in the above-mentioned JP-A-Hei07-123706, the switching frequency of the switching element at low load is controlled by the period of the switching frequency. Thus, the switching frequency cannot be reduced. This disadvantageously increases switching loss.

Moreover, since the PWM comparator 116 performs control in accordance with the difference signal between the voltage of the current detection resistor R and the output of the multiplier 112, the current detection resistor R disadvantageously causes loss.

Typical examples of the present invention are as follows.

A step-up DC-DC converter according to an aspect of the present invention is a step-up DC-DC converter that boosts an input voltage by switching operation so as to generate an output voltage to be provided to a load element. The step-up DC-DC converter includes: a semiconductor switching element; a diode element that is connected to the semiconductor switching element and outputs the output voltage; a control logic that generates a drive voltage to be provided to the semiconductor switching element; a power supply circuit that receives, boosts, and outputs a battery voltage, a buffer that receives the drive voltage generated and outputted by the control logic, receives the voltage outputted by the power supply circuit as a power supply, level-shifts the received drive voltage using the received power supply, and provides the level-shifted voltage to the semiconductor switching element; a voltage detection circuit that receives and detects the battery voltage; and an oscillator circuit that changes the oscillation frequency on the basis of the voltage detected by the voltage detection circuit. The control logic comprises a control circuit for reducing the on/off frequency of the semiconductor switching element when the load element is a low load.

A semiconductor integrated circuit device according to another aspect of the present invention includes: a signal input terminal; a signal output terminal; a battery power supply input terminal; a direct-current voltage input terminal; a semiconductor switching element control output terminal; a semiconductor switching element; a control logic that generates a drive voltage to be provided to the semiconductor switching element; a power supply circuit that receives a battery voltage via the battery power supply input terminal and boosts and outputs the received battery voltage; a buffer that receives the drive voltage generated and outputted by the control logic, receives the voltage outputted by the power supply circuit as a power supply, level-shifts the received drive voltage using the received power supply, and provides the level-shifted drive voltage to the semiconductor switching element via the semiconductor switching element control output terminal; a voltage detection circuit that receives and detects the battery voltage; an oscillator circuit that changes the oscillation frequency on the basis of the voltage detected by the voltage detection circuit; and a load element that has an input thereof connected to the signal input terminal and an output thereof connected to the signal output terminal, receives the battery voltage via the battery power supply input terminal, receives a voltage generated by the semiconductor switching element via the direct-current voltage input terminal, and operates using both the received voltages as power supplies. The signal input terminal, the signal output terminal, the battery power supply input terminal, the direct-current voltage input terminal, the semiconductor switching element control output terminal, the semiconductor switching element, the control logic, the power supply circuit, the buffer, the voltage detection circuit, the oscillator circuit, and the load element are integrally formed on a common semiconductor substrate.

According to the present invention, it is possible to provide a semiconductor integrated circuit device that can suppress the maximum peak current flowing into the inductor coil even if the input voltage range is wide, suppress switching loss at low load, provide power to the load element, and maintain stable operation of the load element.

### BRIEF DESCRIPTION OF THE DRAWINGS

FIG. 1 is a diagram showing the circuit block configuration of a step-up DC-DC converter according to a first embodiment of the present invention;

FIG. 2 is a diagram showing the circuit configuration of a step-up DC-DC converter according to the related art;

FIG. 3A is a graph showing the relationships between an input voltage VBAT, and the value of the peak current flowing into an inductor coil and the oscillation frequency and is a graph showing a case where the oscillation frequency of an oscillation circuit 70 is approximately constant relative to the input voltage VBAT;

FIG. 3B is a diagram showing the relationships between the input voltage VBAT, and the peak current value flowing into the inductor coil and the oscillation frequency and is a graph showing a case where the oscillation frequency of an oscillation circuit 70 is proportionate to the input voltage VBAT;

FIG. 4A includes the timing charts of components of the step-up DC-DC converter according to the present invention that is operating at low load;

FIG. 4B includes the timing charts of components of the related art described in JP-A-Hei07-123706 that is operating at low load;

FIG. 5 is a diagram showing the circuit block configuration of a step-up DC-DC converter where a semiconductor switching element, instead of a diode D according to the first embodiment of the present invention, is used;

FIG. 6 is a diagram showing the circuit block configuration of a step-up DC-DC converter according to a second embodiment of the present invention;

FIG. 7 is a circuit block diagram showing a semiconductor integrated circuit device according to a third embodiment of the present invention where some components of the step-up DC-DC converter according to the present invention and an amplification element serving as a load for the DC-DC converter are integrally formed on a common semiconductor substrate;

FIG. 8 is a diagram showing the circuit block configuration of an example of a high-voltage amplification element used as the amplification element of the semiconductor integrated circuit device according to the present invention; and

FIG. 9 is a diagram showing the circuit block configuration of an example of two high-voltage amplification elements used as the amplification element of the semiconductor integrated circuit device according to the present invention.

### DETAILED DESCRIPTION OF THE PREFERRED EMBODIMENTS

To solve the above-mentioned problems, a step-up DC-DC converter according to an embodiment of the present invention includes a semiconductor switching element, a control logic that generates a drive voltage to be provided to the semiconductor switching element, a power supply circuit that receives, boosts, and outputs a battery voltage, a buffer that receives the drive voltage generated and outputted by the control logic, receives the voltage outputted by the power supply circuit as a power supply, level-shifts the received drive voltage using the received output, and provides the level-shifted voltage to the semiconductor switching element, a voltage detection circuit that receives and detects the battery voltage and outputs a voltage correlated to the detected voltage, and an oscillator circuit that controls the frequency on the basis of the voltage outputted by the voltage detection circuit. The step-up DC-DC converter controls the power supply of a load element that operates using a voltage generated by the semiconductor, switching element as a power supply, by providing the voltage to the load element. That is, the step-up DC-DC converter according to the present invention includes a semiconductor switching element, a control logic that generates a drive voltage to be provided to the semiconductor switching element, and a frequency oscillation means that changes the on/off frequency of the semiconductor switching element on the basis of a voltage detected by a battery power supply voltage detection means. The step-up DC-DC converter performs feedback control such that the number of on/off pulses generated by the semiconductor switching element at low load is reduced and such that the number of on/off pulses generated by the semiconductor switching element at high load is increased.

The control logic may include a circuit that controls the frequency of a signal for controlling the semiconductor switching element, a circuit that controls the duty cycle of a signal for controlling the semiconductor switching element, or both the circuits. The circuit that controls the duty cycle is preferably configured so that the duty cycle is controlled when the load element is started.

The semiconductor switching element is preferably, for example, a field effect transistor (FET) having a drain-source breakdown voltage of approximately 200 V, that is, a so-called high-voltage FET. The load element or amplification element is preferably a so-called high-voltage amplification element, which amplifies a first voltage amplitude (low-voltage amplitude) to a second voltage amplitude (high-voltage amplitude), a voltage amplitude several tens of times greater than the first voltage amplitude.

In particular, a piezoelectric element-driving IC or the like for use in a touch panel for a small device such as a cellular phone is effective in reducing power, since such an element has a long stand-by time, that is, is placed in a non-input (low load) state for a long time.

The step-up DC-DC converter according to another embodiment of the present invention is a step-up DC-DC converter that generates an output voltage to be provided to the load element by boosting the input voltage by switching operation. More specifically, the semiconductor switching element includes a diode element, a control logic, a power supply circuit, a buffer, a voltage detection circuit, and an oscillator circuit. The diode element is connected to the semiconductor switching element and outputs an output voltage. The control logic generates a drive voltage to be provided to the semiconductor switching element. The power supply circuit boosts and outputs the voltage of a battery. The buffer receives the drive voltage generated and outputted by the control logic, receives the voltage outputted by the power supply circuit as a power supply, level-shifts the received drive voltage using the received power supply, and provides the level-shifted voltage to the semiconductor switching element. The voltage detection circuit receives and detects the battery voltage. The oscillator circuit changes the oscillation frequency on the basis of the voltage detected by the voltage detection circuit. In particular, the control logic includes a control circuit for reducing the on/off frequency of the semiconductor switching element when the load element is a low load.

A semiconductor integrated circuit device according to still another embodiment of the present invention includes: a semiconductor switching element; a control logic that generates a drive voltage to be provided to the semiconductor switching element; a power supply circuit that boosts a battery voltage; a buffer that level-shifts the drive voltage outputted by the control logic; a voltage detection circuit that receives and detects the battery voltage and outputs a voltage correlated to the received voltage; an oscillator circuit that controls the frequency on the basis of the voltage outputted by the voltage detection circuit; and an amplification element that operates using a voltage generated by the semiconductor switching element as a power supply.

More specifically, a semiconductor integrated circuit device according to yet another embodiment of the present invention includes: a signal input terminal; a signal output terminal; a battery power supply input terminal; a direct-current voltage input terminal; a semiconductor switching element control output terminal; a semiconductor switching element; a control logic that generates a drive voltage to be provided to the semiconductor switching element; a power supply circuit that receives a battery voltage via the battery power supply input terminal and boosts and outputs the received battery voltage; a buffer that receives the drive voltage generated and outputted by the control logic, receives the voltage outputted by the power supply circuit as a power supply, level-shifts the received drive voltage using the received power supply, and provides the level-shifted drive voltage to the semiconductor switching element via the semiconductor switching element control output terminal; a voltage detection circuit that detects the battery voltage and outputs a voltage correlated to the battery voltage; an oscillator circuit that controls the frequency on the basis of the voltage outputted by the voltage detection circuit; and an amplification element that has an input thereof connected to the signal input terminal and an output thereof connected to the signal output terminal, receives the battery voltage via the battery power supply input terminal, receives a voltage generated by the semiconductor switching element via the direct-current voltage input terminal, and operates using both the received voltages as power supplies. The above-mentioned components are integrally formed on a common semiconductor substrate.

In this case, the control logic, the semiconductor switching element, the load element, and the amplification element are the same as those of the above-mentioned step-up DC-DC converter according to the present invention.

Now, the embodiments of the present invention will be described in detail with reference to the accompanying drawings.

### First Embodiment

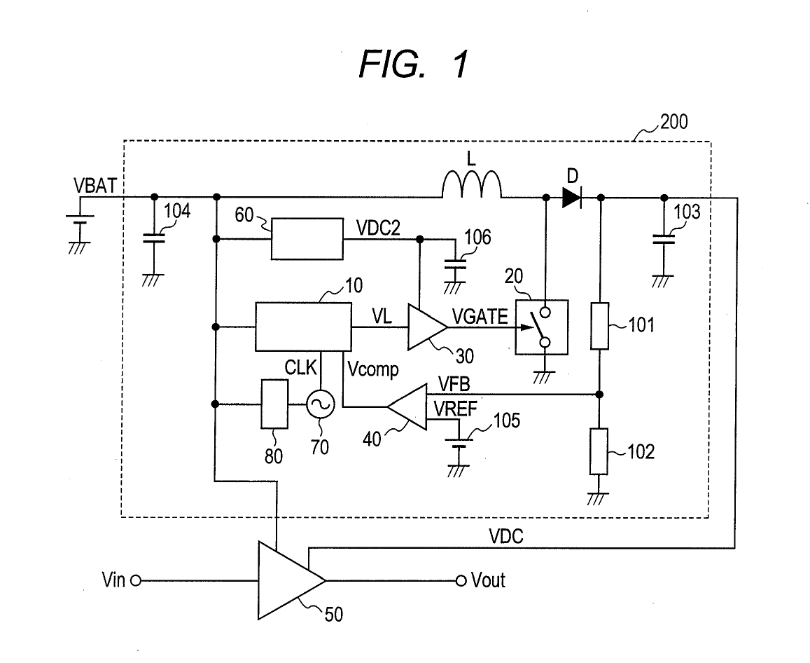

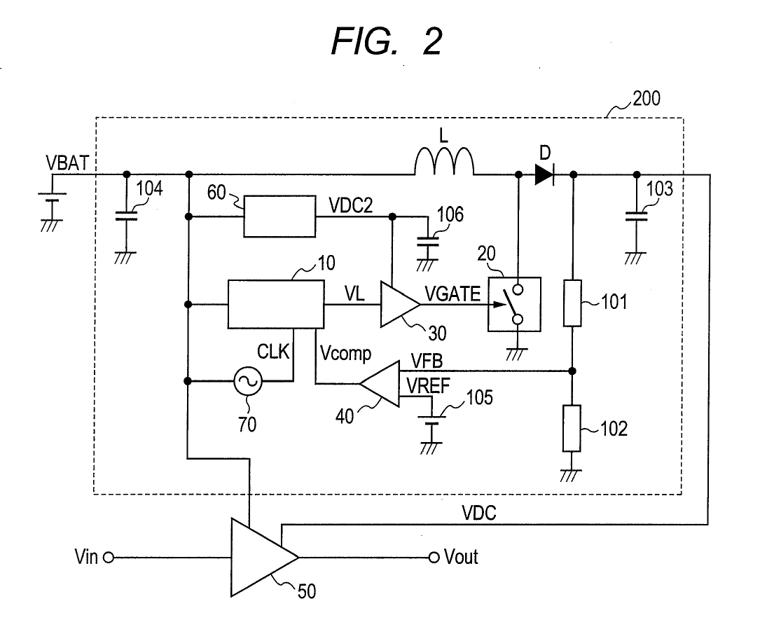

FIG. 1 is a circuit diagram showing a semiconductor integrated circuit device according to a first embodiment of the present invention. A boost control apparatus 200 according to this embodiment provides power to an amplification element 50 using an input voltage VBAT as a power supply.

This semiconductor integrated circuit device includes: an inductor coil L; a semiconductor switching element 20, which switches an output of the inductor coil L; a diode D; a switching control logic circuit 10, which controls switching; a buffer 30, which drives the semiconductor switching element 20; a level-shift power supply circuit 60, which provides power to the buffer 30; an input voltage VBAT detection circuit 80; an oscillator circuit 70, which oscillates on the basis of a voltage outputted by the input voltage VBAT detection circuit 80; resistors 101 and 102 for detecting a power supply output voltage VDC of the boost control apparatus 200; a reference voltage generation circuit 105 for generating a reference voltage VREF for performing feedback control to the control logic circuit 10; a feedback control circuit 40 for causing the switching control logic circuit 10 to generate a control signal; and an amplification element 50.

The switching control logic circuit 10 on/off controls the semiconductor switching element 20. The switching control logic circuit 10 may includes a means for dividing an output signal of the oscillator circuit 70. Typically, the semiconductor switching element 20 include a transistor.

The feedback control circuit 40 receives a feedback voltage VFB generated by dividing the power supply output voltage VDC using the resistors 101 and 102, and the reference voltage VREF. Thus, after the difference voltage between the feedback voltage VFB and the reference voltage VREF is determined, a signal is transmitted to the switching control logic circuit 10 so that the semiconductor switching element is immediately turned off even during the duty cycle. As a result, the power supply output voltage VDC is controlled to an approximately constant voltage.

This feedback control is not control such that a comparison is made between a value obtained by converting a current value corresponding to the inductor coil current into a voltage using the current detection resistors and a value detected by the output voltage detection circuit. For this reason, power loss due to the resistors does not occur.

In the boost control apparatus 200 shown in FIG. 1, the high level of an output of the buffer 30 that receives a power supply from the level-shift power supply circuit 60, that is, the high level of a semiconductor switching element control signal VGATE is VDC2.

The level-shift power supply circuit 60 boosts the input voltage VBAT to a predetermined voltage. The level-shift power supply circuit 60 is controlled to a voltage that is approximately constant relative to the input voltage VBAT. The level-shift power supply circuit 60 can be integrated into the same integrated circuit completely or partially.

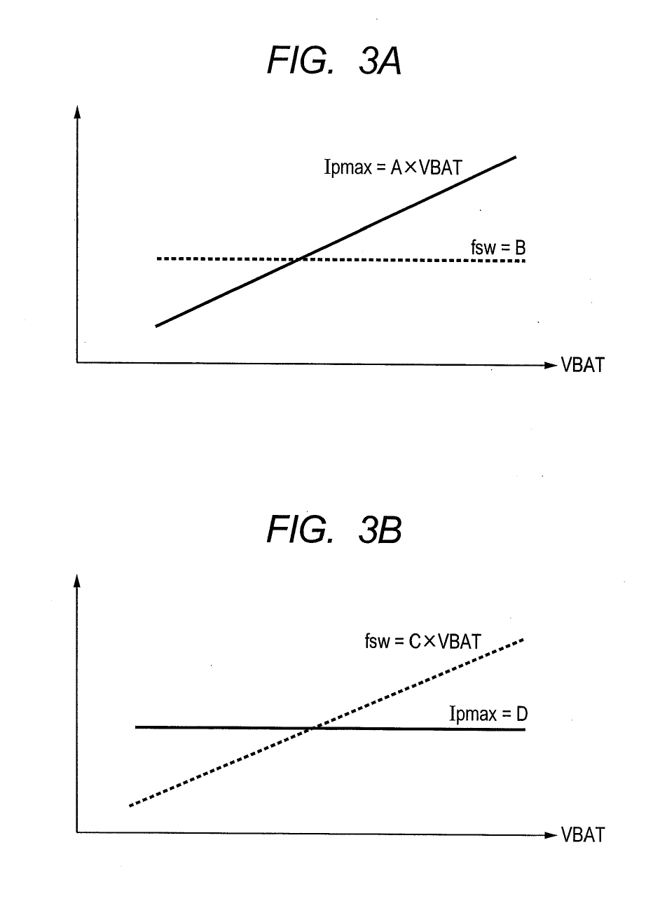

FIGS. 3A and 3B are graphs showing the characteristic exhibited by the oscillation frequency of the oscillator circuit 70 shown in FIG. 1 and that exhibited by the peak current flowing into the inductor coil L as the input voltage VBAT changes.

A maximum peak current Ipmax flowing into the inductor coil L is represented approximately by

Ipmax=VBAT/L×Ton=VBAT×Duty/(L×fsw) (1)

In control according to the present invention, the maximum peak current Ipmax is increased relative to the input voltage VBAT in a case where the oscillation frequency of the oscillator circuit 70 is approximately constant relative to the input voltage VBAT, as in FIG. 3A, since the maximum duty cycle is constant.

On the other hand, by making the oscillation frequency of the oscillator circuit 70 proportionate to the input voltage VBAT, the peak current flowing into the inductor coil L can be made approximately constant, as in FIG. 3B. This prevents an increase in the current passing through the inductor coil L. Thus, magnetic saturation of the inductor coil can be suppressed, enhancing reliability.

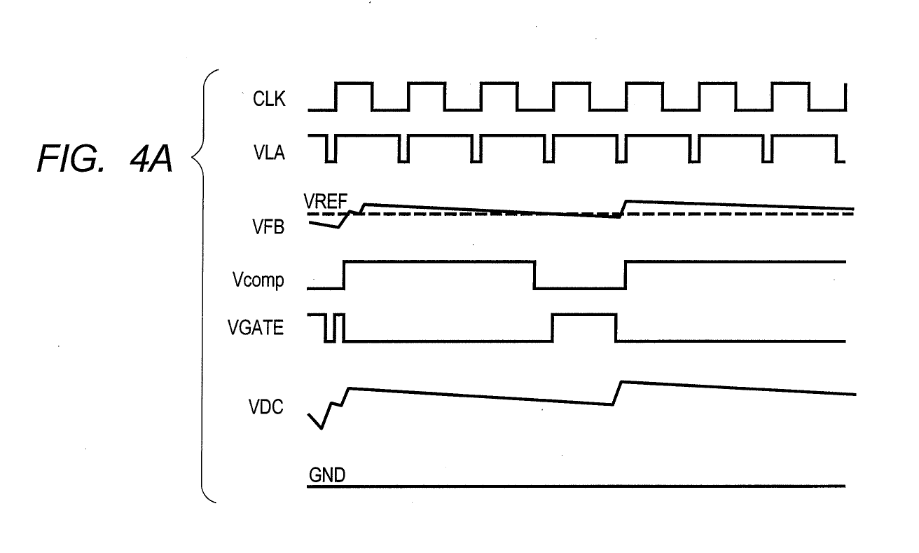

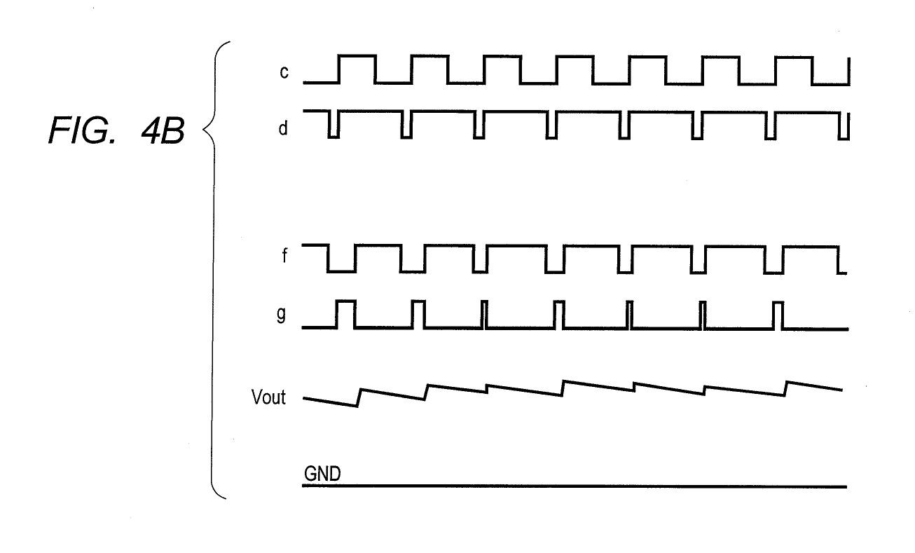

FIGS. 4A and 4B include timing charts during low-load operation. FIG. 4A includes timing charts according to the present invention, and FIG. 4B includes timing charts according to JP-A-Hei07-123706.

The control signal VGATE for turning on or off the semiconductor switching element corresponds to a signal g shown in FIG. 4B. A signal VLA is generated in the switching control logic circuit 10, and its duty cycle is fixed during normal operation. The switching control logic circuit 10 outputs a signal VL on the basis of the signal VLA and a signal Vcomp, and the buffer 30 outputs the signal VGATE. Thus, the switching element 20 is on/off controlled.

Since the input voltage is close to a predetermined voltage at low load, the on time of the signal g is reduced on the basis of a signal f in FIG. 4B. Thus, the switching element is on/off controlled approximately every time.

On the other hand, in FIG. 4A, the switching element is controlled at a certain fixed duty. When the input voltage exceeds the predetermined voltage, the switching element is turned off. If the voltage is higher than the predetermined voltage to some extent at the instant when the switching element is tuned off, the output voltage VDC varies to a lesser extent due to less power consumption at low load, increasing the time before the input voltage decreases to the predetermined voltage. During this period, the on/off control of the switching element is stopped. When the input voltage becomes lower than the predetermined voltage, the on/off control of the switching element is restarted. This reduces the switching frequency. Thus, loss due to switching can be reduced.

While the switching frequency is reduced equivalently, the time during which the switching element is on does not vary, preventing an increase in the maximum peak current.

The level-shift power supply circuit 60 boosts the input voltage VBAT to a predetermined voltage. Thus, the input voltage VBAT can be made higher than the logical threshold voltage of the semiconductor switching element 20. The level-shift power supply circuit 60 is controlled to a voltage that is approximately constant relative to the input voltage VBAT. The level-shift power supply circuit 60 can be integrated into the same integrated circuit completely or partially.

The output voltage VDC2 of the level-shift power supply circuit 60 is controlled to a voltage that is approximately constant relative to the input voltage VBAT. Thus, the approximately constant voltage is outputted as the high level of the semiconductor switching element control signal VGATE. That is, even when the input voltage VBAT varies, the semiconductor switching element 20 can be driven under approximately the same condition. This can maintain stable operation of a load element, the amplification element 50.

The switching control logic circuit 10 may include a soft-start circuit for controlling the inrush current at the start of boost. An example of the soft-start circuit is a circuit that controls the duty cycle at the start of boost. This circuit performs control such that the duty cycle is increased in steps starting with a small duty cycle (for example, approximately 10%) at certain intervals at the start of boost.

The load element 50 may be, for example, an amplification element having a fixed gain, an amplification element having a changeable gain, or the like. However, the load element 50 according to the present invention is not limited thereto, and any type of load element that is required to stabilize the power supply can be used as the load element 50. For example, a high-voltage driver or the like can be used.

The amplification element 50 may be an amplification element having a fixed gain or amplification element having a changeable gain, and the number of units of the amplification element 50 is not limited to one.

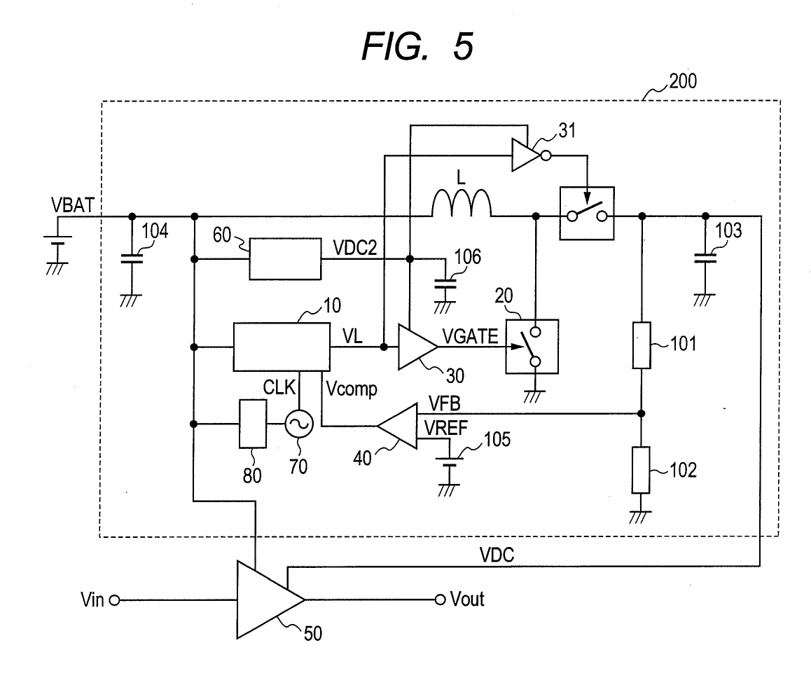

FIG. 5 shows an example where a semiconductor switching element, instead of the diode D, is used.

### Second Embodiment

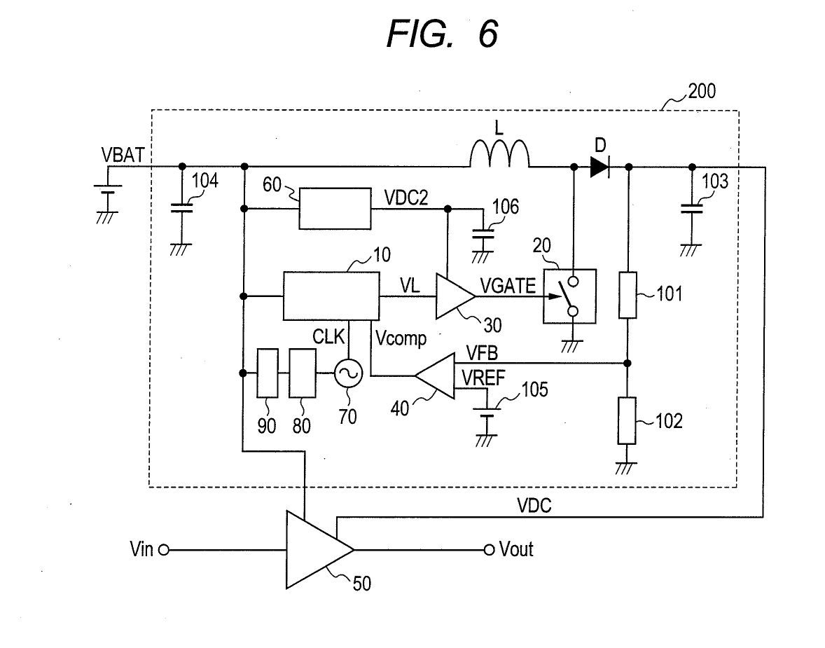

The components of a step-up DC-DC converter according to a second embodiment of the present invention are approximately the same as those of the first embodiment. As shown in FIG. 6, the only difference is that a filter circuit 90 is connected between the input voltage VBAT and the input voltage VBAT detection circuit 80. In this embodiment, the control means for on/off controlling the switching element 20 has the same mode as the first embodiment.

In this embodiment, the input voltage VBAT passes through the filter circuit, so the output voltage of the input voltage VBAT detection circuit 80 varies to a lesser extent as the input voltage varies abruptly. Thus, a variation in oscillation frequency can be suppressed.

### Third Embodiment

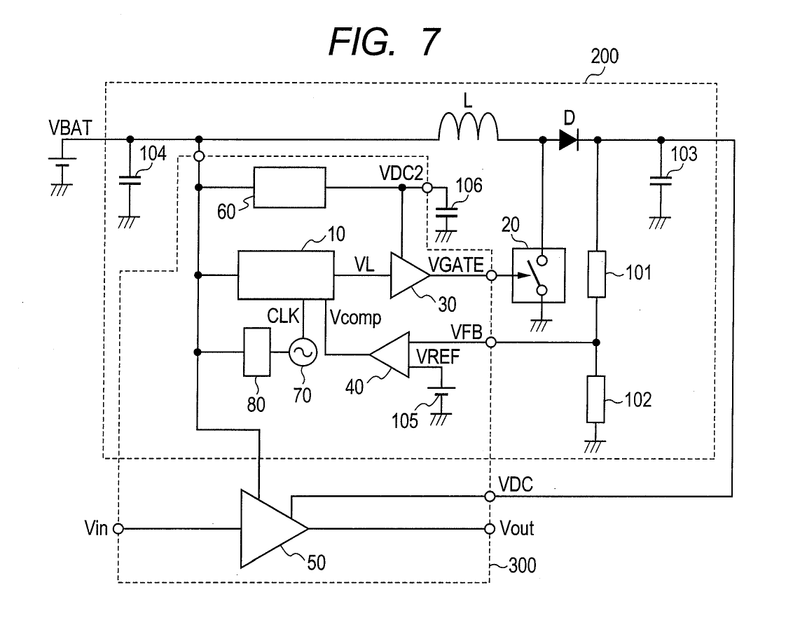

FIG. 7 is a circuit block diagram showing a semiconductor integrated circuit device according to a third embodiment of the present invention where some components of the step-up DC-DC converter according to the present invention and the amplification element used as a load for the DC-DC converter are integrally formed on a semiconductor common substrate. The boost control apparatus 200 according to this embodiment provides power to the amplification element 50 using the input voltage VBAT as a power supply.

A semiconductor integrated circuit device 300 according to this embodiment includes at least: the semiconductor switching element 20; the switching control logic circuit 10, which controls switching of the semiconductor switching element 20; the buffer 30, which drives the semiconductor switching element 20; the level-shift power supply circuit 60, which provides power to the buffer 30; the input voltage VBAT detection circuit 80; the oscillator circuit 70, which oscillates on the basis of a voltage outputted by the input voltage VBAT detection circuit 80; and the amplification element 50. These components are provided on a common semiconductor substrate. The reference voltage generation circuit 105, which generates the reference voltage VREF for performing feedback control to the switching control logic circuit 10, and the feedback control circuit 40 for causing the switching control logic circuit 10 to generate a control signal may further be incorporated and integrated into the semiconductor integrated circuit device 300. However, the present invention is not limited to this aspect. On the other hand, the inductor coil L, the semiconductor switching element 20 for switching an output of the inductor coil L, and the resistors 101 and 102 for detecting the direct-current power supply output voltage VDC are preferably components externally attached to the semiconductor integrated circuit device 300.

The semiconductor integrated circuit device 300 includes at least a signal input terminal Vin, a signal output terminal Vout, a battery power supply input terminal VBAT, a direct-current power supply input terminal VDC, and a semiconductor switching element control output terminal VGATE. The signal input terminal Vin is connected to the input of the amplification element 50, and an input signal is inputted into the amplification element 50 via the signal input terminal Vin. The signal output terminal Vout is connected to the output of the amplification element 50, and a signal amplified and outputted by the amplification element 50 is outputted from the semiconductor integrated circuit device 300 via the signal output terminal Vout. The battery power supply input terminal VBAT is connected to the switching control logic circuit 10, the level-shift power supply circuit 60, the input voltage VBAT detection circuit 80, the oscillator circuit 70, and the amplification element 50. Thus, the voltage of the external battery is provided to the switching control logic circuit 10, the level-shift power supply circuit 60, the input voltage VBAT detection circuit 80, the oscillator circuit 70, and the amplification element 50 via the battery power supply input terminal VBAT. The direct-current power supply input terminal VDC is connected to the amplification element 50. A stabilized direct-current voltage generated by the operation of the semiconductor switching element 20 is provided to the amplification element 50 via the direct-current power supply input terminal VDC. The semiconductor switching element control output terminal VGATE is connected to the output of the buffer 30. A drive voltage level-shifted by the buffer 30 and the level-shift power supply circuit 60 is provided to the semiconductor switching element 20 via the semiconductor switching element control output terminal VGATE. In a case where the reference voltage generation circuit 105, which generates the reference voltage VREF for performing feedback control to the switching control logic circuit 10, and the feedback control circuit 40 for causing the switching control logic circuit 10 to generate a control signal are provided inside or outside the semiconductor integrated circuit device 300, the semiconductor integrated circuit device 300 further includes a feedback voltage input terminal VFB. In particular, in a case where the reference voltage generation circuit 105 and the feedback control circuit 40 are incorporated in the semiconductor integrated circuit device 300, the feedback voltage input terminal VFB is connected to the input of the feedback control, circuit 40. A feedback voltage signal generated by the operation of the semiconductor switching element 20 and by the resistors 101 and 102 is inputted into the feedback control circuit 40 via the feedback voltage input terminal VFB. In a case where a ground capacitance 106 is provided outside the semiconductor integrated circuit device 300, the semiconductor integrated circuit device 300 further includes a terminal for connecting the ground capacitance 106 to the level-shift power supply circuit 60 and the buffer 30.

The switching control logic circuit 10 on/off controls the semiconductor switching element 20. The switching control logic circuit 10 may include a means for dividing an output signal of the oscillator circuit 70. Typically, the semiconductor switching element 20 include a transistor.

The feedback control circuit 40 receives the feedback voltage VFB generated by dividing the power supply output voltage VDC using the resistors 101 and 102, as well as receives the reference voltage VREF. Thus, after the difference voltage between the feedback voltage VFB and the reference voltage VREF is determined, a signal is transmitted to the switching control logic circuit 10 so that the semiconductor switching element is immediately turned off even during the duty cycle. As a result, the power supply output voltage VDC is controlled to an approximately constant voltage.

In the semiconductor integrated circuit device 300 shown in FIG. 7, the high level of an output of the buffer 30 that receives a power supply from the level-shift power supply circuit 60, that is, the high level of the semiconductor switching element control signal VGATE is VDC2.

The level-shift power supply circuit 60 boosts the input voltage VBAT to a predetermined voltage. The level-shift power supply circuit 60 is controlled to a voltage that is approximately constant relative to the input voltage VBAT. In the example shown in FIG. 7, the level-shift power supply circuit 60 is completely integrated in the semiconductor integrated circuit device 300; however, the present invention is not limited to the aspect. For example, the level-shift power supply circuit 60 may be a component that is partially integrated in the semiconductor integrated circuit device 300 and partially attached thereto externally.

The oscillation frequency characteristic of the oscillator circuit 70 shown in FIG. 7 is similar to that (FIG. 3B) of the oscillator circuit 70 according to the first embodiment in FIG. 1. That is, by making the oscillation frequency of the oscillator circuit 70 proportionate to the input voltage VBAT, the peak current flowing into the inductor coil L can be made approximately constant. This prevents an increase in the current flowing into the inductor coil L. Thus, magnetic saturation of the inductor coil can be suppressed, enhancing reliability.

Moreover, the on/off control characteristic of the switching element 20 at low load is similar to that of the first embodiment shown in FIG. 4A. That is, the switching frequency is reduced, loss due to switching is reduced, and efficiency is increased. Thus, power consumption can be reduced.

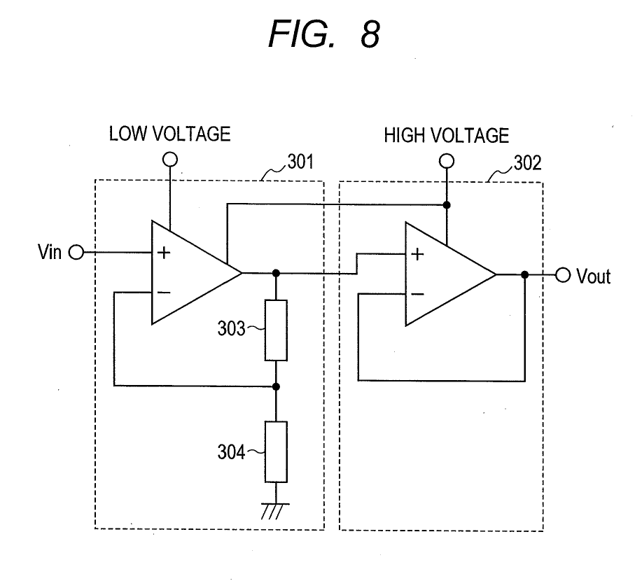

FIG. 8 is a diagram showing the circuit block configuration of an example of a high-voltage amplification element used as the amplification element 50 of the semiconductor integrated circuit device 300. The high-voltage amplification element includes a non-inversion amplifier 301 and voltage followers 302 and 303. The power supply of the high-voltage amplification element may include a low voltage source and a high voltage source, and the voltages of the low and high voltage sources may be, for example, 3 to 5 V and 150 V, respectively. The high-voltage amplification element amplifies a low-voltage amplitude (for example, Vin=1.8 Vpp) to a high-voltage amplitude (for example, 100 Vpp).

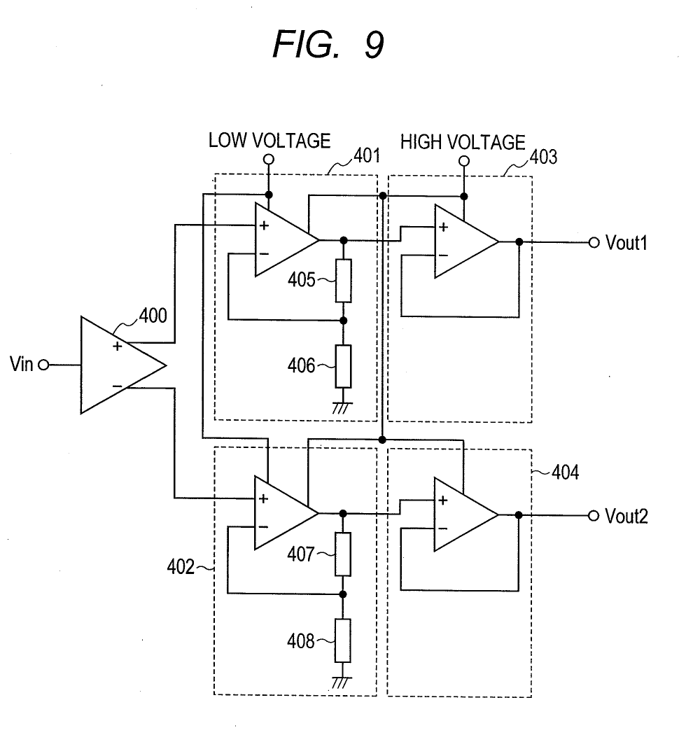

FIG. 9 is a diagram showing the circuit block configuration of an example of two high-voltage amplification elements used as the amplification element 50 of the semiconductor integrated circuit device 300. The high-voltage amplification elements include a single-differential converter 401, non-inversion amplifiers 402 and 403, and voltage followers 404 and 405. The difference voltage between VOUT1 and VOUT2 may be used as the output, or two terminals VOUT1 and VOUT2 may be used independently. The power supply of the high-voltage amplification elements may include a low voltage source and a high voltage source, and the voltages of the low and high voltage sources may be, for example, 3 to 5 V and 150 V, respectively. The high-voltage amplification elements amplify a low-voltage amplitude (for example, Vin=1.8 Vpp) to a high-voltage amplitude (for example, differential 200 Vppd).

The high-voltage amplification element may include a soft-start circuit that controls the inrush current at the start of boost. An example of the soft-start circuit is a circuit that controls the duty cycle at the start of boost. This circuit performs control such that the duty cycle is increased in steps starting with a small duty cycle (for example, approximately 10%) at certain intervals at the start of boost.

The amplification element 50 may be, for example, an amplification element having a fixed gain, amplification element having a changeable gain, or the like; however, the amplification element 50 according to the present invention is not limited thereto. Any type of load element that is required to stabilize the power supply can be used as the amplification element 50.

What is claimed is:

1. A step-up DC-DC converter that boosts an input voltage by switching operation so as to generate an output voltage to be provided to a load element, the step-up DC-DC converter comprising:
a semiconductor switching element;
a diode element that is connected to the semiconductor switching element and outputs the output voltage;
a control logic that generates a drive voltage to be provided to the semiconductor switching element;
a power supply circuit that receives, boosts, and outputs a battery voltage;
a buffer that receives the drive voltage generated and outputted by the control logic, receives the voltage outputted by the power supply circuit as a power supply, level-shifts the received drive voltage using the received power supply, and provides the level-shifted voltage to the semiconductor switching element;
a voltage detection circuit that receives and detects the battery voltage; and
an oscillator circuit that changes the oscillation frequency on the basis of the voltage detected by the voltage detection circuit,
wherein the control logic comprises a control circuit for reducing the on/off frequency of the semiconductor switching element when the load element is a low load.

2. The step-up DC-DC converter according to claim 1, wherein the control logic includes a circuit that controls the frequency of a signal for controlling the semiconductor switching element.

3. The step-up DC-DC converter according to claim 1, wherein the control logic includes a circuit that controls the duty cycle of a signal for controlling the semiconductor switching element.

4. The step-up DC-DC converter according to claim 3, wherein the control logic further includes a circuit that controls the frequency of a signal for controlling the semiconductor switching element.

5. The step-up DC-DC converter according to claim 3, wherein the circuit that controls the duty cycle controls the duty cycle when the load element is started.

6. The step-up DC-DC converter according to claim 5, wherein the control logic further includes a circuit that controls the frequency of a signal for controlling the semiconductor switching element.

7. The step-up DC-DC converter according to claim 1, wherein the semiconductor switching element is a field-effect transistor having a drain-source breakdown voltage of approximately 200 V.

8. The step-up DC-DC converter according to claim 1, wherein the load element is an amplification element that amplifies a first voltage amplitude to a second voltage amplitude which is a voltage amplitude several tens of times greater than the first voltage amplitude.

9. The step-up DC-DC converter according to claim 1, wherein the diode element is replaced with a semiconductor switching element.

10. A semiconductor integrated circuit device comprising:
a signal input terminal;
a signal output terminal;
a battery power supply input terminal;
a direct-current voltage input terminal;
a semiconductor switching element control output terminal;
a control logic that generates a drive voltage to be provided to the semiconductor switching element;
a power supply circuit that receives a battery voltage via the battery power supply input terminal and boosts and outputs the received battery voltage;
a buffer that receives the drive voltage generated and outputted by the control logic, receives the voltage outputted by the power supply circuit as a power supply, level-shifts the received drive voltage using the received power supply, and provides the level-shifted drive voltage to the semiconductor switching element via the semiconductor switching element control output terminal;
a voltage detection circuit that receives and detects the battery voltage;
an oscillator circuit that changes the oscillation frequency on the basis of the voltage detected by the voltage detection circuit; and
a load element that has an input thereof connected to the signal input terminal and an output thereof connected to the signal output terminal, receives the battery voltage via the battery power supply input terminal, receives a voltage generated by the semiconductor switching element via the direct-current voltage input terminal, and operates using both the received voltages as power supplies,
wherein the signal input terminal, the signal output terminal, the battery power supply input terminal, the direct-current voltage input terminal, the semiconductor switching element control output terminal, the semiconductor switching element, the control logic, the power supply circuit, the buffer, the voltage detection circuit, the oscillator circuit, and the load element are integrally formed on a common semiconductor substrate.

11. The semiconductor integrated circuit device according to claim 10, wherein the control logic includes a circuit that controls the frequency of a signal for controlling the semiconductor switching element.

12. The semiconductor integrated circuit device according to claim 10, wherein the control logic includes a circuit that controls the duty cycle of a signal for controlling the semiconductor switching element.

13. The semiconductor integrated circuit device according to claim 12, wherein the control logic further includes a circuit that controls the frequency of a signal for controlling the semiconductor switching element.

14. The semiconductor integrated circuit device according to claim 12, wherein the circuit that controls the duty cycle controls the duty cycle when the load element is started.

15. The semiconductor integrated circuit device according to claim 14, wherein the control logic further includes a circuit that controls the frequency of a signal for controlling the semiconductor switching element.

16. The semiconductor integrated circuit device according to claim 10, wherein the semiconductor switching element is a field-effect transistor having a drain-source breakdown voltage of approximately 200 V.

17. The semiconductor integrated circuit device according to claim 10, wherein the load element is an amplification element that amplifies a first voltage amplitude to a second voltage amplitude which is a voltage amplitude several tens of times greater than the first voltage amplitude.
